(19) United States
(12) Patent Application Publication
(10) Pub. No.: US 2020/0034754 A1
(43) Pub. Date: Jan. 30, 2020

(54) SYSTEM AND METHOD FOR RECOMMENDING AND BOOKING TRAVEL RESERVATIONS

(71) Applicant: Fernando Fortini, Hollywood, FL (US)

(72) Inventor: Fernando Fortini, Hollywood, FL (US)

(21) Appl. No.: 16/049,340

(22) Filed: Jul. 30, 2018

(51) Int. Cl. G06Q 10/02; G06Q 50/14; G06Q 30/02; G06F 17/30; G06Q 30/06

(52) U.S. Cl. CPC G06Q 10/02; G06Q 50/14; G06Q 30/0641; G06F 17/30867; G06Q 30/0281

(57) ABSTRACT

A system and method for recommending and booking travel reservations includes a system services environment for generating and supporting a website, a traveler mobile application and an agent mobile application. The system includes functionality for uploading traveler preferences for storage by the system environment server, receiving a particular travel destination from a traveler, and matching the traveler with an agent who has expert knowledge of the travel destination and shared preferences with the traveler. The system includes functionality for the agent to prepare an itinerary for the traveler, and to adjust a commission that affects the price of the itinerary for consideration by the traveler. The system also includes functionality for allowing the traveler to directly book the itinerary with the system upon acceptance of the itinerary and price.

### TECHNICAL FIELD

The present invention relates generally to innovations in travel reservation systems, and more particularly to a system and method that allows travelers and local experts to profit from travel recommendations and subsequent travel bookings.

### BACKGROUND

The statements in this section merely provide background information related to the present disclosure and may not constitute prior art.

There are many existing travel websites such as Expedia and Travelocity, for example that are popular amongst travelers. Each of these websites work with any number of travel destination companies such as various hotels, and/or reservation network groups, for example, to offer competitive travel rates to site users.

Although these systems provide options for other users to leave reviews about specific hotels, activities and/or past experiences, for example, there is little incentive for such users to do so. Moreover, there is no personal attention that is given to users of these sites as they operate on a volume/mass market philosophy.

Accordingly, it would be beneficial to provide a travel reservation system that can encourage local experts (e.g., people familiar with a certain geographic area) to act as travel agents that can provide personalized travel destination recommendation services to travelers, and to make a commission from each booking that is made from the recommendation.

The present invention, directed to a system and method for recommending and booking travel reservations differs from the conventional art in a number of aspects. The manner by which will become more apparent in the description which follows, particularly when read in conjunction with the accompanying drawings.

### SUMMARY OF THE INVENTION

The present invention is directed to a system and method for recommending and booking travel reservations. One embodiment of the present invention can include a system services environment for generating and supporting a website, a traveler mobile application and an agent mobile application. Upon establishing communication, a traveler can provide the system with preferences for storage by the system environment server. The preferences can include non-travel related information such as a business industry, religion, favorite foods and beverages, music types, activities and so forth.

In one embodiment, the traveler can search the system for travel related information pertaining to a particular travel destination. Upon receipt of the travel destination, the system can match the traveler with an agent who has expert knowledge pertaining to the travel destination. If there are multiple experts available for a particular travel destination, the system can match the traveler to the available expert whose uploaded personal preferences are most closely aligned with those of the traveler.

In one embodiment, the matched agent can prepare an itinerary for the traveler to consider based on the agents firsthand knowledge of the area and the shared preferences. The itinerary can include an original/recommended price for the identified travel activities, or a reduced price that can be adjusted by the agent. If the traveler likes the recommended itinerary, they can book travel through the system and the agent can receive a commission. Alternatively, if the traveler declines to book the recommended itinerary, the agent can be notified in order to provide the agent with a second chance to reduce the price.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 shows an exemplary network environment according to some embodiments of the technology.

FIG. 2 shows an exemplary flow diagram illustrating a traveler method for booking travel reservations utilizing the network environment, according to one embodiment.

FIG. 3 shows an exemplary traveler interface of the system of FIG. 1.

FIG. 4 shows an exemplary flow diagram illustrating a method for recommending and booking travel reservations utilizing the network environment, according to one embodiment.

FIGS. 5A-5C show exemplary agent interface presentation screens of the system of FIG. 1.

FIG. 6 shows another exemplary traveler interface of the system of FIG. 1.

### DETAILED DESCRIPTION OF THE INVENTION

One embodiment of a system and method for recommending and booking travel reservations is provided below. Unlike traditional mass market travel reservation sites, the present system is designed to encourage anyone with experience or knowledge of a particular area to become an area-expert agent who can generate and send specific itineraries to travelers and be compensated when the traveler books a trip.

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

Identical reference numerals are used for like elements of the invention or elements of like function. For the sake of clarity, only those reference numerals are shown in the individual figures which are necessary for the description of the respective figure.

### Definitions

As described herein, the terms “user” and “traveler” can be used interchangeably to describe any person who utilizes one or more aspects of the system and method to receive travel-related information, and/or who books or receives travel information from an agent using the system.

The terms “agent” and “expert” can be used interchangeably to describe any person who utilizes one or more aspects of the system and method to research, generate and/or send travel-related information to a user.

The term “travel-related information” and “travel content” can be used interchangeably to describe information obtained through the system resources pertaining to a travel destination and related industries. Several nonlimiting examples include lodging information, pricing and booking options for hotels, motels, vacation apartments, vacation homes, bed and breakfast, hostels, etc., transportation services information pricing and booking options for airplane, train, boat, taxi, rental cars, rideshare, etc., and activities information pricing and booking options for cruises, tours, attraction tickets, restaurants etc.

The term “supplier” can be used to describe any person, entity or group who generates the travel related information, and/or offers the destination services described in the travel related information (e.g., the actual hotel, airline, attraction, etc.). Suppliers can also include authorized agents and wholesalers (e.g., bed bankers like GTA, hotelbeds, Tourico, Expedia, etc.).

The term “system administrator” can be used to describe the individual, group or legal entity that is overseeing the below described system 100, in order to perform the methods described herein. Additionally, such terms describe the individuals overseeing the system services environment.

In various embodiments, the system and method for recommending and booking travel reservations can include a website entitled “takeabed.com”, however any number of different URL addresses are also contemplated. Additionally, it is contemplated that several different methods and/or method steps can be performed simultaneously via different websites that are directed towards different individual markets, travel styles (e.g., adventure, luxury . . . ) and/or geographic locales. Such methods can be performed under the direct supervision of the original system administrator, or via secondary system administrators through a franchise or other agreement.

In various embodiments, one or more aspects of the system can include, utilize and/or be presented in the form of one or more mobile applications (i.e., App) called “takeabed” that can be downloaded and installed as an application for use on a portable electronic device. In the preferred embodiment, the system can include a Traveler App, having functionality for use by travelers, and an Agent App, having functionality for use by agents. Of course, the inventive concepts disclosed herein are not to be construed as limiting to a mobile application, as virtually any type of instruction sets, in any form of programming language that can be executed on any type of processor enabled device are also contemplated.

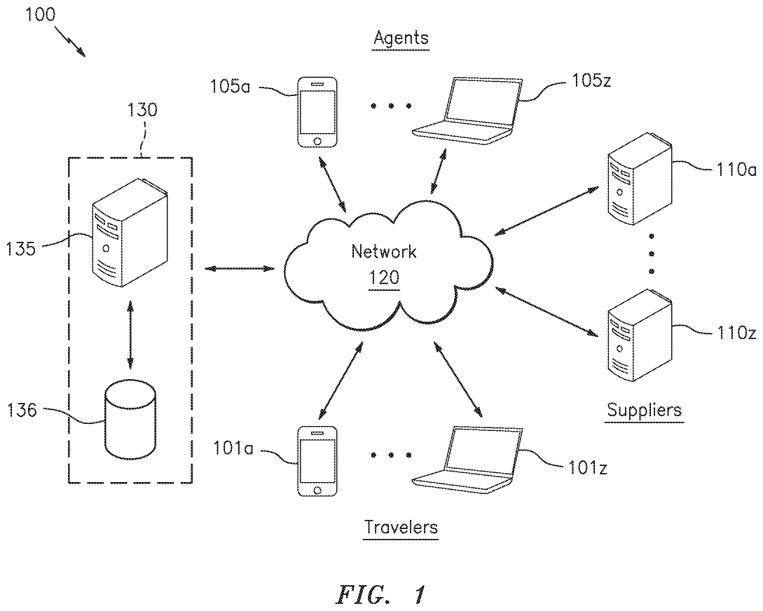

FIG. 1 is a schematic illustration of an exemplary operating environment 100 for implementing a system for recommending and booking travel reservations. As shown, the system 100 can include any number of users operating a user interface device 101a-101z, any number of agents operating an agent interface device 105a-105z, any number of suppliers each operating an interface device 110a-110z, a communication network 120 and a system services environment 130.

Each of the interface devices can be any type of computing device that is operable by a human user. A computing device refers to any device with a processor and memory that can execute instructions and communicate with another device. Computing devices include, but are not limited to, smartphones, tablet computers, personal computers, laptop computers and/or purpose built machines that are pre-encoded with an application interface, so as to perform the functionality so described. In either instance, each of the computing devices can include one or more client applications, such as a conventional web browser, and/or an application interface, for example, which can allow the device to communicate with other interface devices and/or the system services environment 130.

As will be described below, the user interface devices 101 can be operated by a traveler to view, book and receive travel related information; the agent interface devices 105 can be operated by an agent to view, generate and send travel related information to a user; the supplier interface devices 110 can be used by suppliers to offer destination services to agents, who can then offer the same to travelers; and the system services environment 130, can facilitate communication between the interface devices, as will be described below.

In various embodiments, the system services environment 130 includes, comprises or consists of one or more interface devices 135 that are connected to one or more databases 136 on which various portions of the system and method can be performed. In various embodiments, one or more of the interface devices 135 can include, comprise or consist of a web server, an email server, an application database server and so forth, or the system can employ a single server device which functions to handle each of these processes.

The database 136 can function to receive and store any form of information, and can include any type of computer-readable storage mediums, including all forms of volatile and non-volatile memory such as, for example, semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. In addition, the devices can be operatively coupled to a communications network, such as network 120, to receive instructions and/or data from the network and/or to transfer instructions and/or data to the network.

The database can function to house any number of computer program products, i.e., a computer program tangibly embodied in a non-transient machine-readable storage device, for execution by, or to control the operation of, a data processing apparatus. The computer programs can be written in any form of computer or programming language, including source code, compiled code, interpreted code, scripting code (e.g., JavaScript) and/or machine code, and the computer program can be deployed in any form, including as a stand-alone program or as a subroutine, element, or other unit suitable for use in a computing environment.

As such, the database 136 can function to store the system operating instructions for generating the website presentation screens and the mobile applications for implementing the below described methodology. The database can also store travel-related information, contact details, and profiles of system users in order to allow the system to match travelers with local experts, as will be described below.

The network 120 can be any type of network, including a local area network (“LAN”), such as an intranet, a wide area network (“WAN”), such as the internet, or any combination thereof. Further, the communication network 120 can be a public network, a private network, or a combination thereof. The communication network 120 can also be implemented using any number of communications links associated with one or more service providers, including one or more wired communication links, one or more wireless communication links, or any combination thereof. Additionally, communication network 120 can be configured to support the transmission of data formatted using any number of protocols.

To facilitate communication via the network, each of the interface devices can also include a communication interface configured to receive a communication, such as a request, data, etc., from another computing device in network communication with the computing device and pass the communication along to an appropriate module running on the computing device. The communication interface can also be configured to send a communication to another computing device in network communication with the computing device.

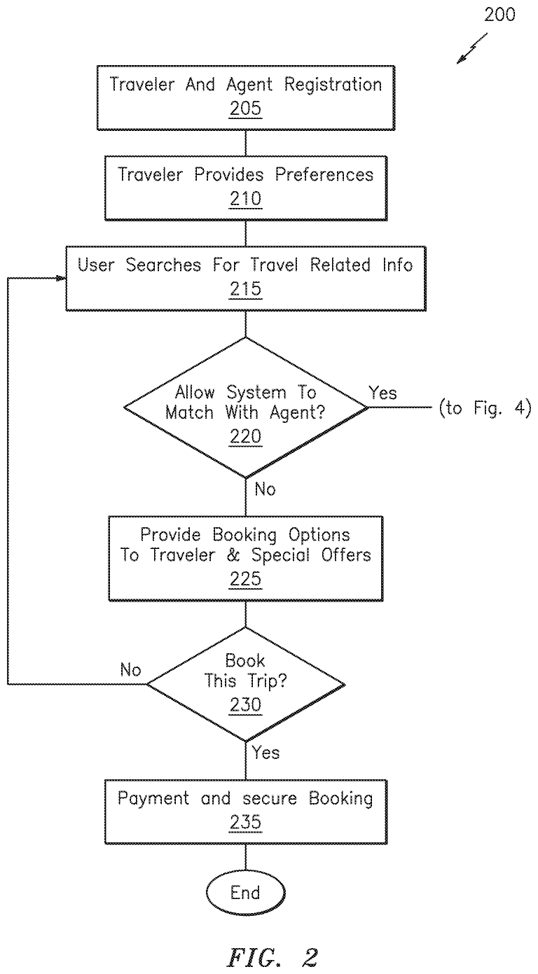

FIG. 2 illustrates one embodiment of a method 200 for recommending and booking travel reservations utilizing the network system 100. Although described below with respect to particular steps and screens, this is for illustrative purposes only, as the methodology described herein can be performed in a different order than shown, and the presentation screens can include any number of additional information and features.

The method can begin at step 205 wherein travelers 101 and agents 105 can register accounts with the system environment 130, and can be provided access to the system. Access to the system may be through a website, and/or through mobile applications such as a dedicated traveler App for use by travelers, and a dedicated agent App for use by agents. Although outside the scope of this document, the registration process for agents can include paid or unpaid options, so as to allow agents the opportunity to receive wholesale pricing from suppliers.

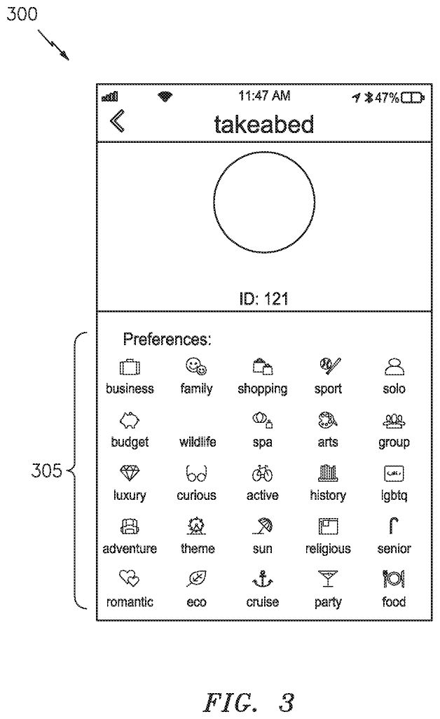

At step 210, the system can generate a presentation screen to gather personal and lifestyle related information of travelers and agents. For example, FIG. 3 illustrates one embodiment of a traveler preferences presentation screen 300 that can be generated by the system environment 130 and delivered to the user interface device 101 via the mobile App or through the system website. As shown, the presentation screen 300 can allow the traveler to provide their preferences across a wide-ranging field of personal and lifestyle categories 305. These may include, for example, the traveler's business industry, religion, favorite sporting activities, artists, food and activities, for example.

As will be described below, this information can be stored in the system database and can be used by the system to match travelers with specific agents based on the shared preferences and/or experience of both parties. For example, if the traveler belongs to a particular religion which does not allow certain types of food to be consumed, an appropriately matched agent will know not to recommend particular restaurants to the traveler because the agent will know that he or she also cannot eat there. The same logic follows for activities such as concerts (based on shared musical interests), bars, etc.

Such a feature ensures the traveler will be provided with the best possible travel-related information from someone who likes the same things as the traveler, and has been to or lives in the travel destination selected by the user.

At step 215, a traveler can search the travel-related information provided by the system. In the preferred embodiment, the traveler will conduct the search via the user App described above. The traveler can search the information to identify a specific travel destination, and can be provided with any number of expected options including available hotels, rental vehicles, activities, etc., that are available at the travel destination for the users dates of travel and number of travelers in the party. Behind the scenes, the system services environment 130 can query any number of suppliers to receive and generate the travel destination information for the user.

At step 220, the system can provide additional and non-traditional options to the traveler. For example, the system can provide the traveler with the option to be matched with an agent who is a location expert for the area in which the traveler is searching. If the traveler chooses this option, the system can move to step 225 wherein the system services environment can match the traveler to an agent.

In one embodiment, the matching process can first identify agents that have significant ties to the identified travel destination e.g., lives there, operates a business there or routinely travels there, and next can utilize any number of different algorithms to compare the user preferences supplied by the user at step 210 with those provided by agents during their registration process. Based on the results of the matching process, the system can recommend an agent who is intimately familiar with the travel destination and shares similar interests with the traveler. Such features advantageously allow the agent to recommend tours, attractions and even restaurants based on the known preferences of the traveler. Upon identifying such items, the method can proceed A to step 405 of method 400.

If the traveler declines to be matched with an agent, the method can proceed to step 225 wherein an itinerary containing the pricing and booking information can be provided to the traveler. At this time, the system can encourage the user to purchase the itinerary by offering any number of different special offers. For example, the system can offer to provide the user with a cash reward if they book now using the system app. Of course, any number of other options can also be provided.

At step 230 the user can decide whether or not to book the itinerary. If the user decides yes, the method can proceed to step 235 wherein payment can be received, and travel can be booked with the selected suppliers. Alternatively, if the user decides not to book the trip, the method can return to step 215 wherein the user can be provided with additional and/or different travel related information.

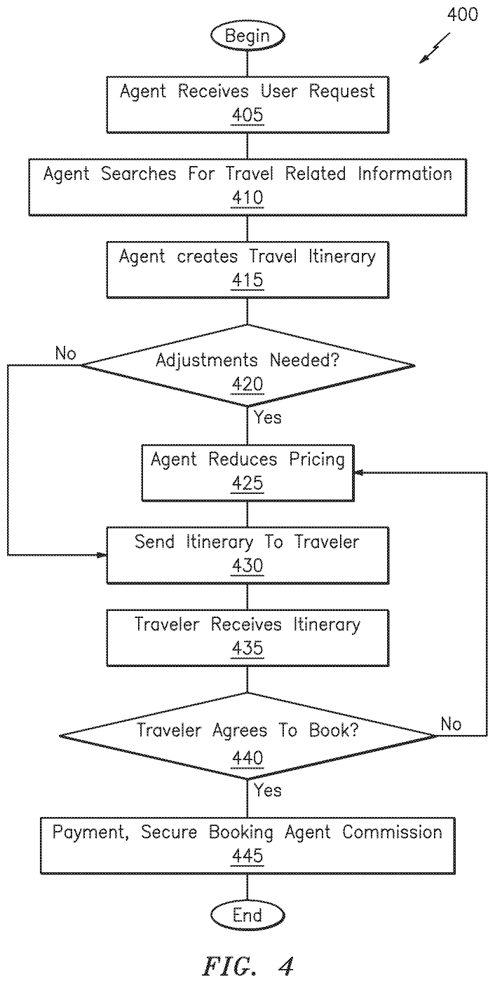

FIG. 4 illustrates another 400 for recommending and booking travel reservations utilizing the network system 100. Although described below with respect to particular steps and screens, this is for illustrative purposes only, as the methodology described herein can be performed in a different order than shown, and the presentation screens can include any number of additional information and features.

The method can begin at step 405 wherein an agent can be notified that a traveler is interested in booking a trip to an area in which the agent is an expert. In one embodiment, the notification can be a direct transfer A from the system services environment of a traveler from step 220 above. This transfer can include opening a chat screen and/or establishing direct communication via a telephone or video conference, for example. Alternatively, the agent can be contacted by a traveler who found the agent through a system database and/or through the recommendation of another system user. Of course, travelers can also reach out to agents directly based on past bookings with the agent or acquaintances. In either instance, once the agent has been provided with the travel destination, dates and other pertinent information the method can proceed to step 410.

At step 410, the agent can search the travel-related information provided by the system. In the preferred embodiment, the agent will conduct the search via the agent App described above. In this regard, the agent can utilize their firsthand knowledge of the travel destination to find available hotels, rental vehicles, activities, etc., based on the users dates of travel and number of travelers in the party.

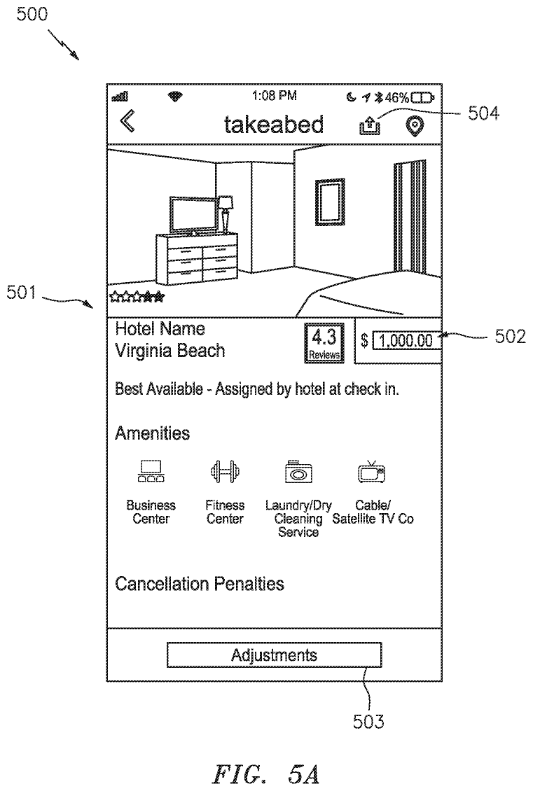

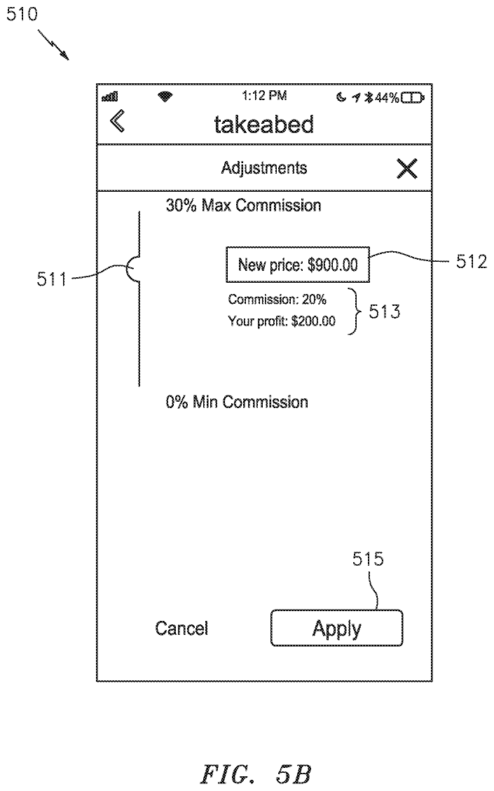

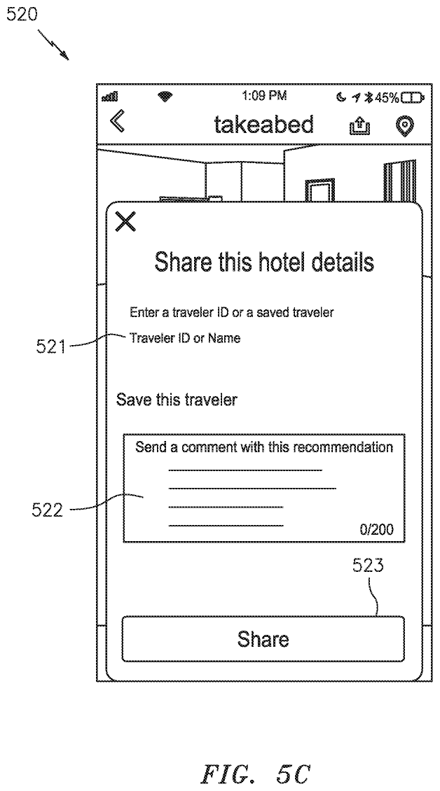

At step 415, the agent can create an itinerary for the traveler, and can be provided with standard pricing information. For example, FIG. 5A illustrates one embodiment of an itinerary presentation screen 500 that can be generated by the system environment 130 and presented to the user interface device 105 via the mobile App or through the system website. As shown, the itinerary screen 500 can include an identification of the itinerary item 501, in this instance a hotel room, along with pricing information 502 for the dates specified by the user.

Next, the method can proceed to step 420 wherein the agent can decide to adjust their commission, which adjusts the user price, or the agent can send the itinerary to the user at the listed price. If the agent decides to adjust their commission, the method can proceed to step 425. Alternatively, if the agent decides not to adjust their commission, the agent can select the share icon 504, and the method can proceed to step 430.

In step 425, the agent can decide to adjust their commission by selecting the adjustments icon 503. FIG. 5B illustrates one embodiment of an adjustment presentation screen 510 that can be generated upon selection of the adjustment icon. As shown, the screen 510 can provide information pertaining to the available commission offered to the agent, and options for adjusting the agent commission to reduce the overall cost to the traveler. In one embodiment the screen can include an adjustment mechanism, such as a sliding bar 511 that can be selectively engaged by the agent. As the agent moves the bar 511 prices and commission rates are adjusted and displayed in real time. These details can include the adjusted price 512 to be offered to the user, along with commission percentage and the resulting profit to the agent 513. Once the agent has made the adjustment, they can select the apply icon 515, and the method can proceed to step 430.

At step 430, the agent can send the generated itinerary to the traveler. FIG. 5C illustrates one embodiment of a share details presentation screen 520 for the agent to complete. As shown, the screen can allow the agent to identify 521 the particular traveler for whom the itinerary was created, and provide any comments or suggestions 522 prior to sending 523 the same to the traveler.

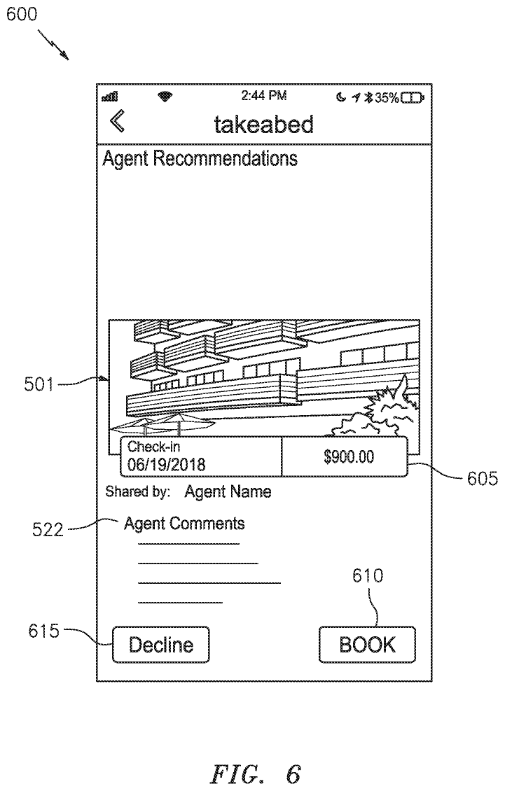

At step 435, the traveler can receive the itinerary from the agent. FIG. 6 illustrates one embodiment of an agent recommendation presentation screen 600 which can be displayed on the traveler interface device 101. As shown, the screen can include the identification of the itinerary item 501, the agent name and comments inputted at 522 and pricing information 605. Pricing information 605 will be either the original price identified above at 502 or the adjusted price identified at 512.

At step 440 the traveler can decide to accept or decline the itinerary. If the traveler accepts the itinerary, they can select the book icon 610, and the method can proceed to step 445 wherein payment can be received, travel can be booked with the selected suppliers, and the agent can be paid their commission. Alternatively, if the traveler does not wish to book the itinerary, they can select the decline icon 615, wherein the method can return to step 425 and the agent can be given the opportunity to adjust their commission again.

Accordingly, the above described system and method provides a unique approach to planning and booking travel by engaging and rewarding individuals with expertise about a travel destination. Although described above with regard to particular method steps and presentation screens containing particular options, this is for illustrative purposes only. To this end, any number of different method steps and/or presentation screens can be provided for performing the functionality described herein.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the terms “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A computer implemented method for recommending and booking travel reservations, the method comprising:
establishing communication between a traveler interface device, an agent interface device, and a system services environment;
uploading, via the traveler interface device, user preferences about a user of the traveler interface device;
storing, via a system database, the uploaded user preferences;
providing, via the traveler interface device, a travel destination;
matching, via the system services environment, the user of the traveler interface device with an agent utilizing an agent interface device;
searching, via the agent interface device, travel-related information for the travel destination of the user;
generating, via the agent interface device, a travel itinerary for the travel destination of the user;
sending the travel itinerary to the traveler interface device of the user; and
booking, via the traveler interface device, the travel itinerary.

2. The computer implemented method of claim 1, wherein the matching comprises:
identifying a plurality of agents that have ties to the travel destination;
comparing the user preferences of the user and a user preference of each of the identified plurality of agents; and
pairing the user with an agent having a highest amount of matching user preferences.

3. The computer implemented method of claim 2, wherein the user preferences comprises:
personal or lifestyle information about the user.

4. The computer implemented method of claim 1, wherein the travel-related information for the travel destination of the user includes an original price.

5. The computer implemented method of claim 4, further comprising:
providing the agent with options for adjusting the original price.

6. The computer implemented method of claim 5, wherein the options include reducing a commission percentage to reduce the original price to a reduced price.

7. The computer implemented method of claim 6, wherein the itinerary includes the original price or the reduced price.

8. The computer implemented method of claim 7, further comprising:
paying the agent a commission based on the original price or the reduced price.

9. The computer implemented method of claim 1, further comprising:
providing direct communication options between the user of the traveler interface device and the matched agent.

10. The computer implemented method of claim 9, wherein the direct communication options include a real time text chat session utilizing the traveler interface device and the agent interface device.

11. The computer implemented method of claim 9, wherein the direct communication options include a voice call session utilizing the traveler interface device and the agent interface device.

12. The computer implemented method of claim 9, wherein the direct communication options include a video chat session utilizing the traveler interface device and the agent interface device.
